(19) United States
(12) Patent Application Publication
(10) Pub. No.: US 2009/0031003 A1
(43) Pub. Date: Jan. 29, 2009

(54) Color Coding Web Site Presentation

(75) Inventor: Debora Velarde, Beaverton, OR (US)

Correspondence Address: LIEBERMAN & BRANDSDORFER, LLC, 802 STILL CREEK LANE, GAITHERSBURG, MD, 20878, US

(73) Assignee: International Business Machines Corporation, Armonk, NY (US)

(21) Appl. No.: 11/828,378

(22) Filed: Jul. 26, 2007

(51) Int. Cl. G06F 15/173

(52) U.S. Cl. 709/217

(57) ABSTRACT

A method and apparatus are provided for customizing a web site and images therein based upon the color preference of a user accessing the web site. One or more images selected for presentation on a web site are categorized based upon a predominant color in the image. Similarly, a user color preference is obtained for viewing the web site. If the user color preference differs from the image color categorization, the web site images are replaced with images with a color spectrum matching the user color preference, if a matching replacement image is available.

### BACKGROUND OF THE INVENTION

1. Technical Field

This invention relates to customizing a web site according to a color preference of a visitor. More specifically, the invention relates to categorizing images to be presented on a web site based upon a color palette and displaying select images from a palette based upon the determined color preference.

2. Description of the Prior Art

Web sites use various schemes to provide some level of customization or adaptation to the individual user accessing the site(s). Customization may include content displayed to the user. For example, where a user has visited the site on a prior occasion, personal and historical information, such as the user's name, account activity, payment method, etc. may be stored at the site. This information stored at the site can be retrieved the next time the user visits the site. The stored information may be used to personalize the web session for the user. Historical information stored by a web site can also be used to customize advertising. With respect to electronic commerce, the objective of these customization mechanisms is to guide the user towards relevant purchases, whether by supporting selection of products for the user or promoting products of potential interest to the user. The customization techniques are based upon information supplied by the user during past visits to the web site.

Each time the user visits a new web site, the information gathering process necessary for the operation of customization mechanisms must be repeated. It can take some time before the customization mechanisms are effective. However, there are shortcomings associated with using historical data to customize a web site for a user. For example, if the user is visiting a previously traveled web site but for a different purpose, such as purchasing a product for a different person, they will most likely is viewing different products offered at the site. If the historical information used for customization is based on past visits, then this information is likely to be inapplicable. Accordingly, there are limitations associated with applying historical data to current or future accesses to one or more web sites.

As noted above, electronic commerce web sites may employ technology to customize a repeated visit to the web site. Color is an aspect of a web site that can be modified to enhance a web site visit. Color contrast problems are known in the art for web browsers viewing web pages. Web page programmers are known to select background and text colors. There are no standard background and text color combinations on the internet. Background colors can make the overlying text hard to read. Internet users with visual impairments may have a hard time discerning text on a web page if the contrast between the background and text is not properly selected.

With the growth of the internet, web site developers and marketing teams spend time and money to create web sites that are inviting for people to navigate their site. In addition to selecting text color and background colors, effort is placed on selecting which images to display on the web site. There are several approaches associated with image selection for a site, including changing the images on a periodic basis to keep the site fresh.

However, there are factors associated with image selection that are not apparent with text and background selection. Images are known to have a plurality of colors, and placement of an image with the background of the web page is one factor in delivering an inviting site. One factor in selecting an image is to ensure that the colors in the image do not distract the eyes of the viewer from the text, collide with the text, or blend with the text. Different people who access a particular web site may have different color preferences for viewing. It is known in the art to change text color and background color on a browser based on user set preferences. However, this does not change the colors associated with the images, as the images are remote from the browser. To date, it is not known to modify an image to tailor a web site based on user color preferences. Image color, just like text and background color, affects a web page presentation. Accordingly, there is a need for a tool to modify the web site selection arrangement to include the image and image properties.

### SUMMARY OF THE INVENTION

This invention comprises a method and system to enhance the presentation of a web site by coordinating the presentation of images with characteristics of the web site.

In one aspect of the invention, a method is provided for developing a web site. A grouping of one or more images is placed in a collection. Each image in the collection of images is classified with at least one color attribute. The color attribute classification reflects at least one of the colors in the image. A color preference is obtained for the web page. At least one of the images from the collection is displayed on the web page. The displayed image has a color associated with the color preference of the web page.

In another aspect of the invention, a computer system is provided with a processor in communication with storage media and a visual display. A collection of images for display on a web page are stored on the storage media. An image manager is provided to classify each of the images in the collection with at least one color attribute. The image manager is in communication with the processor and the collection of images. The color attribute classification reflects a color in the image. A development manager is provided in communication with the image manager. The development manager obtains a color preference for the web page. The visual display that is in communication with the development manager displays at least one of the images from the collection.

In yet another aspect of the invention, an article is provided with a computer readable carrier including computer program instructions configured to select one or more images to be displayed on a web page. Instructions are provided to classify each image in a collection of images with at least one color attribute. The color attribute classification reflects a color in the image. Instructions are also provided to obtain a color preference for the web page, and to display at least one of the images from the collection on the web page. The displayed image has a color associated with the color preference of the web page.

In an even further aspect of the invention, an article is provided with a tangible computer readable carrier including computer program instructions configured to select one or more images to be displayed on a web page. Instructions are provided to create a collection of images for display on a web page, and to classify each of the images in the collection with at least one color attribute. The color attribute classification reflects a color in the image. Instructions are also provided to obtain a color preference for the web page. Based upon the obtained color preference, instructions are provided to display at least one of the images from the collection on the web page. The displayed image has a color associated with the color preference of the web page.

Other features and advantages of this invention will become apparent from the following detailed description of the presently preferred embodiment of the invention, taken in conjunction with the accompanying drawings.

### BRIEF DESCRIPTION OF THE DRAWINGS

FIG. 1 is a flow chart illustrating a process for selecting and categorizing images based on color.

FIG. 2 is a block diagram of a data structure employed to organize the images in a single library of images.

FIGS. 3A and 3B is a flow chart illustrating a process for organizing images to create a coordinated web site.

FIG. 4 is a flow chart illustrating a process for customizing a developed web site based upon color preferences according to the preferred embodiment of this invention, and is suggested for printing on the first page of the issued patent.

FIG. 5 is a block diagram illustrating a color categorization and selection tool in a computer system

### DESCRIPTION OF THE PREFERRED EMBODIMENT

### Overview

Browsing the Internet involves visiting one or more web sites for various reasons, including gathering information, shopping, and purchasing product. For the most part, each web site is unique and includes features and characteristics that differentiate them from other sites. Most web sites include a combination of text and art work, wherein the art work is in the form of images, banners etc. There is generally some selection, arrangement, and coordination of the color scheme of the web site that includes the coordination of the images thereon. For example, the background color is selected to bring out the text and images. Similarly, the color of the images is selected so that they complement the color arrangement of the background and text. In general, it is desired that the color of the images on the site complement the color of the background and at the same time are clearly visible to a user browsing the site. To make the web site inviting for the user, the color preference(s) of the user is obtained and the presentation of the images are changed to conform to the user color preference(s). Accordingly, the visit of the user is customized and enhanced through the selection of one or more appropriately classified image(s).

### Technical Details

The internet is a large distributed network of web sites located at specific locations, with each location identified by an address. Web sites are more likely to attract visitors if they are customized and configured to the individual needs of a user browsing the site. Currently, web sites that are used for electronic commerce monitor purchases and encourage future purchases by the user. The invention addresses modifying and customizing a web site based upon the color preference of the user browsing and/or accessing the site. Most web sites include one or more graphic images. These images may be photographs, banners, various forms of artwork, etc. Each image on a web site may be classified into various categories, including color. By classifying or categorizing an image based on color, the web site developer may provide artistic balance to the site.

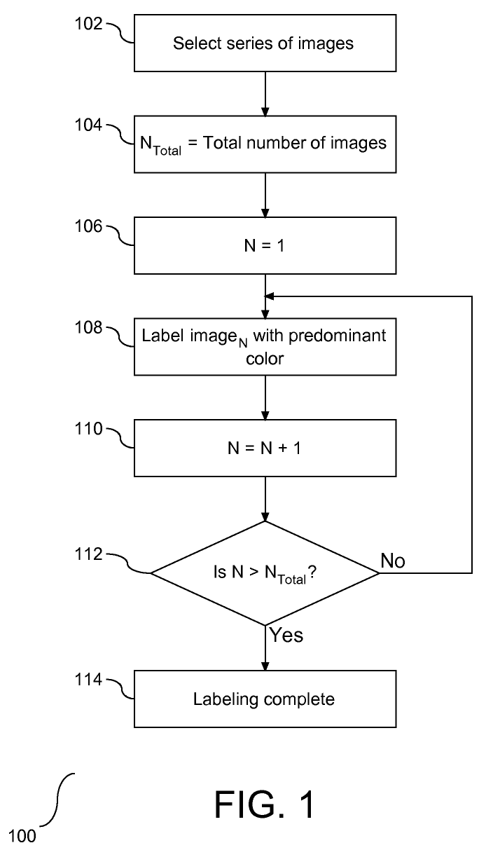

FIG. 1 is a flow chart (100) illustrating a process for selecting and categorizing images based on color. Initially, a series of images are selected for electronic display on a computer system (102). The images may include photographs, banners, artwork, etc. In addition, the images may be intended for viewing on a visual display of a computer system, as well as for viewing on a web site. The images selected at step (102) may be a library of images, wherein one or more of the images may be placed within the program code for viewing on the visual display of a computer system. Hereinafter, it is assumed that the selected images are in a library of images, although the invention is not limited to selection of images in a library of images. In one embodiment, the images may be organized in a directory or organized in a structure that is not defined as a library. Regardless of whether or not it is a library, a directory, or an alternative stored system, the images are labeled based upon their dominant color. Following the selection of images, the variable Nₜₒₜₐₗ is assigned to the total quantity of images in the selected library (104), and the variable N is assigned to the integer value one (106). Each of the images in the library is assigned a label associated with a predominant color in the image. In one embodiment, the predominant color may be the background color of the image, the foreground color of the image, or the primary color of the image. Next, the image in the library associated with the integer N is labeled with the predominant color in that specific image (108). Following the assignment at step (108), the variable N is incremented (110), followed by a determination as to whether there are other images in the library that require labeling (112). If the response to the determination at step (112) indicates there are other images that require labeling, the process returns to step (108) to label the next image in the library. However, if the response to the determination at step (112) indicates that all of the images in the library have been labeled, then the labeling of the images in the library is complete (114). Accordingly, the process for labeling images by color categorizes each image in a library based on a predominant color in the image.

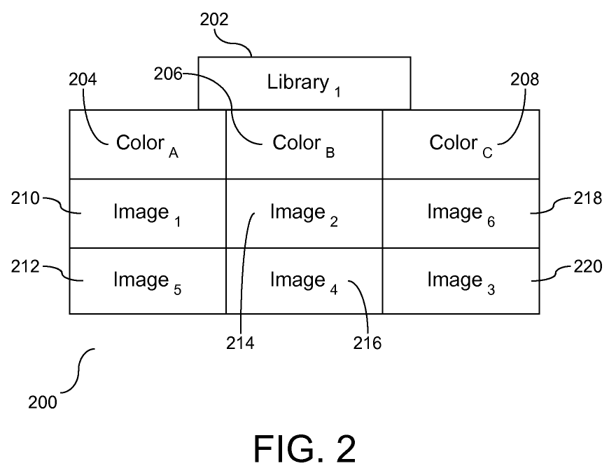

There are various alternatives in which a color assigned to an image may be stored in association with the image. FIG. 2 is a block diagram (200) of an example of a data structure employed to organize the images in a library of images (202). In one embodiment, the library (202) stores a collection of images that relate to a common theme or topic. As shown in this example, there are three colors, color_{A} (204), color_{B} (206), and color_{C} (208). The invention should not be limited to categorizing images in the library to three color categories as shown in this example. In one embodiment, there may be additional color categories for categorizing the images. As shown in this example, there are a total of six images in the library. Each of the images have been assigned to one of the three colors in the library indicating that each of the images in the library have a predominant color that matches with one of the three color categories. More specifically, image₁ (210) and image₅ (212) have been assigned to color_{A} (204); image₂ (214) and image₄ (216) have been assigned to color_{B} (206); and image₆ (218) and image₃ (220) have been assigned to color_{C} (208). Each of the images in the library (202) has a common theme and may be appropriate for display and viewing on the web site. Accordingly, each image in a library of images is placed in a color spectrum based upon the predominant color present in the image.

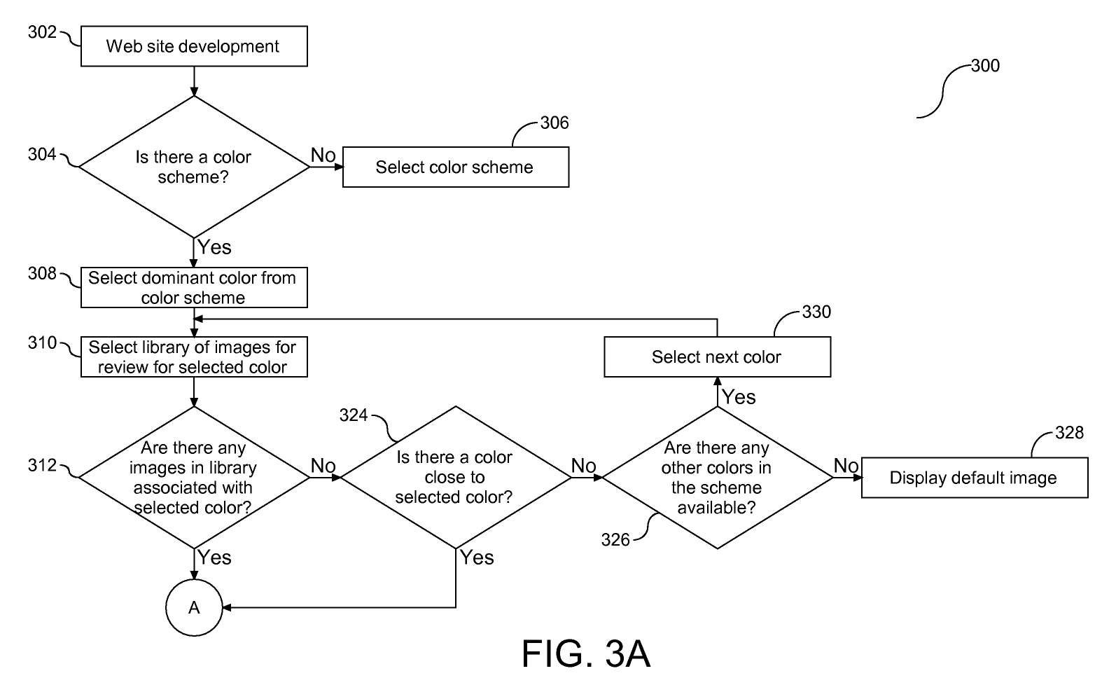

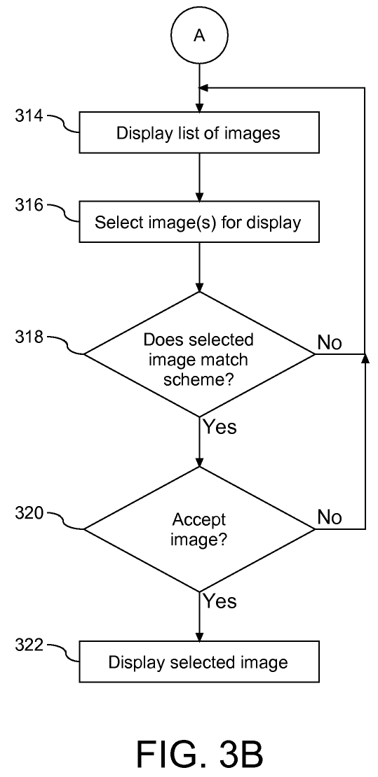

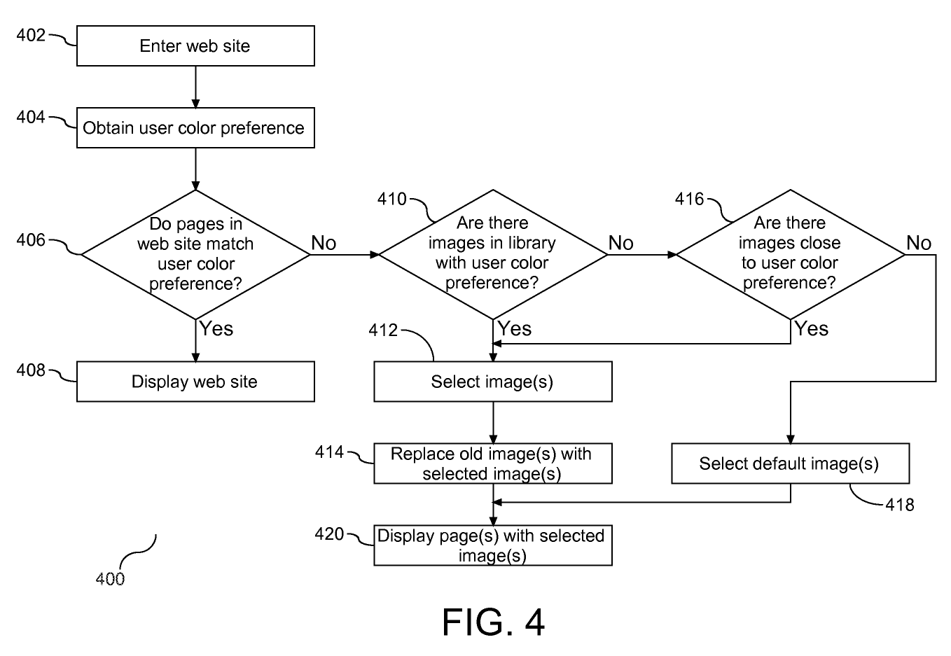

Following the process of labeling images in a library and organizing the labeled images, the organization may be employed to select images for a web site that coordinate with the color scheme for the web site. FIGS. 3A and 3B are a flow chart (300) illustrating a process for utilizing the organization of images based upon a predominant color in each image to create a coordinated web site. In one embodiment, the web site may be developed and programmed and a tool may be employed to change the color of the images or selection of images based upon a user color preference. This embodiment is described in detail below in reference to FIG. 4. With respect to developing a web site with one or more specific color preferences or schemes, the process of the development is outlined herein with respect to FIGS. 3A and 3B. During the web site development process (302), an initial determination is conducted as to whether there is a color scheme selected by the web site developer by or on behalf of the client site for the images to be presented and/or displayed on the web site (304). In one embodiment, a color scheme is a plan or arrangement that may include more than one color as a design implementation. If there is no pre-determined color preference, the color preference is determined (306). Following the process of determining the color preference at step (306), or if the response to the determination at step (304) indicates the color preference is known, a color is selected from the color scheme (308). In one embodiment, the color scheme may include more than one color, wherein the selection of a color at step (308) may include selection of a dominant color in the scheme. Once a color for the scheme is selected, a library of images is selected for review of images categorized with the selected color (310). In one embodiment, the web site may have a content theme with the images to be presented are selected based upon their content. Different libraries of images may be available to select and display on the web site. The developer selects a library that is likely to have images that are desirable for the theme and color coordination of the site. Accordingly, a library of images is selected for review based upon identification of a color scheme and/or content.

The images in the library may be organized according to various features and characteristics including colors, as shown in FIG. 2. A determination is conducted as to whether any of the images in the library selected are categorized with the color preference selected (312). If the response to the determination at step (312) is positive, this is an indication that there is at least one image in the library that is appropriate for selection based upon the color assignment. A listing of images in the library that match the color preference selected is presented (314), and at least one of the images from the library is selected for display (316). Based upon the image display, it is determined whether or not the image matches the intended scheme of the web site (318). There may be various factors that are included in the process of matching the image with the web site, including content, theme, and color. If the response to the determination at step (318) is negative, the process returns to step (314) to start the process of selecting another image from the previously identified library. Similarly, if the response to the determination at step (318) is positive, a determination is conducted as to whether the user wants to accept the image for the web site (320). If the response to the determination at step (320) is negative, the process again returns to step (314) to start the process of selecting another image from the previously identified library. Similarly, if the response to the determination at step (320) is positive, the image is selected for the web site and displayed thereon (322). Accordingly, the process outlined above enables a user to select an image for a web site with the image having a color assignment that matches the theme of the web site.

The process outlined and described in detail above enables an image categorized by color with a color matching a specified color preference for a web site to be selected and displayed on the web site. However, there may be a situation where the library of images selected does not include an image with a color preference that matches the color theme of the web site. In designing a web site and selecting one or more images for the site, the content of the image has to be correct. If the response to the determination at step (312) is negative, this is an indication that there is no image in the library of images selected with a matching color preference. Thereafter, a subsequent determination is conducted as to whether there is a color spectrum of one of more images in the library with a color assignment that is close to the selected color preference (324). In one embodiment, color closeness may be determined by the hex value assignment to the images. Similarly, in one embodiment, the closeness may be selected by arrangement of the images in the associated library or directory. A negative response to the determination at step (324) is followed by a determination whether there are any images in the selected library with one or more colors associated with the previously identified scheme (326). If the response to the determination at step (326) is negative, a default image is selected for display (328). In contrast, if the response to the determination at step (326) is positive, another color is selected (330) followed by a return to step (310). A positive response to the determination at step (324) proceeds to step (314) to complete the image selection process. Accordingly, the image selection process for a web site includes images that match a selected color as well as images that may not be an exact match, but are acceptable within a color palette for display on the web site.

As shown above, the initial selection of images for a web site is controlled by a web site developer. However, following the creation of the web site, the color scheme may be varied to enhance viewing of the web site by visitors. FIG. 4 is a flow chart (400) illustrating the process for customizing a developed web site based upon user determined color preferences. When the user enters a developed web site (402), a color preference for the user is obtained (404). There are various known processes for obtaining a users color preference, including employment of cookies, tracking user history of web sites traveled, and even directly querying the user for a specific color preference. A determination is then conducted (406) as to whether the color scheme of one or more pages that comprise the web site match the color preference obtained at step (404). In one embodiment, the color scheme of the web site is defined at the time of creation of the web site, as demonstrated in FIGS. 3A and 3B, or dynamically determined based upon the predominant colors of the image(s) therein. If the response to the determination at step (406) is positive, the pages of the web site are displayed (408). However, if the response to the determination at step (406) is negative, a subsequent determination (410) is conducted as to whether there are any images in the library of images of the web site that are within the same color spectrum as the color preference obtained at steps (404). If the response to the determination at step (410) is positive, one or more images in the library that are within the color spectrum of the color preference of the user are selected for presentation (412), followed by a replacement of one or more old images with the comparable new images (414). However, if the response to the determination at step (410) is negative, this is an indication that the user color preference does not match the color of the images in the library. It is then determined (416) whether there are any images in the library with a color assignment that is close to the user color preference obtained at step (404). A positive response to the determination at step (416) proceeds to step (412) for selection of images, and a negative response to the determination at step (416) is followed by a selection of one or more default image(s) (418). Once the replacement image(s) has been selected at either step (414) or (418), the web site with the new image(s) coordinated with the user color preference is presented to the user on a visual display (420). Accordingly, the color preference of the user may be obtained to dynamically customize a previously programmed web site.

In one embodiment, the invention is implemented in software, which includes but is not limited to firmware, resident software, microcode, etc. The invention can take the form of a computer program product accessible from a computer-usable or computer-readable medium providing program code for use by or in connection with a computer or any instruction execution system. For purposes of this description, a computer-usable or computer readable medium can be any apparatus that can contain, store, communicate, propagate, or transport the program for use by or in connection with the instruction execution system, apparatus, or device.

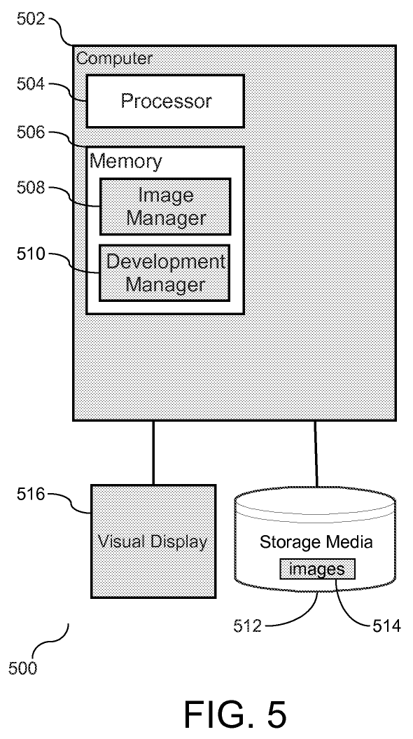

FIG. 5 is a block diagram (500) illustrating a color categorization and selection tool in a computer system. The illustration shows a computer (502) with a processor (504) and memory (506). The processor (504) is in communication with storage media (512). As shown in FIG. 5, the storage media houses a collection of images (514) stored thereon. In one embodiment, the collection of images may be in the form of an image library. The computer (502) also includes memory (506) with an image manager (508) in communication with a development manager (510). The image manager (508) communicates with both the processor and the collection of images in the storage media (514) to classify each of the images in the collection with one or more color attributes. In one embodiment, the color attribute classification reflects a color in the image. The development manager (510) communicates with the image manager to obtain a color preference for the web page. In addition, as illustrated above in FIGS. 3A and 3B, if the development manager finds an image in the library with a matching color, the development manager (510) displays a selected image from the collection (514) on the visual display (516). The image manager (508) and the development manager (510) may reside in memory (506), as shown, and utilize instructions in a computer readable medium to mediate selection of an image for presentation on the visual display (516). Similarly, in one embodiment, the managers (508) and (510) may reside as hardware tools external to memory (506), or they may be implemented as a combination of hardware and software in the computer (502). Accordingly, the managers (508) and (510) may be implemented as a software tool or a hardware tool to facilitate selection of one or more images for display on a visual display (516).

Embodiments within the scope of the present invention also include articles of manufacture comprising program storage means having encoded therein program code. Such program storage means can be any available media which can be accessed by a general purpose or special purpose computer. By way of example, and not limitation, such program storage means can include RAM, ROM, EPROM, CD-ROM, or other optical disk storage, magnetic disk storage or other magnetic storage devices, or any other medium which can be used to store the desired program code means and which can be accessed by a general purpose or special purpose computer. Combinations of the above should also be included in the scope of the program storage means.

The medium can be an electronic, magnetic, optical, electromagnetic, infrared, or semiconductor system (or apparatus or device) or a propagation medium. Examples of a computer-readable medium include but is not limited to a semiconductor or solid state memory, magnetic tape, a removable computer diskette, random access memory (RAM), read-only memory (ROM), a rigid magnetic disk, and an optical disk. Current examples of optical disks include compact disk B read only (CD-ROM), compact disk B read/write (CD-R/W) and DVD.

A data processing system suitable for storing and/or executing program code includes at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks.

The software implementation can take the form of a computer program product accessible from a computer-useable or computer-readable medium providing program code for use by or in connection with a computer or any instruction execution system.

### Advantages Over the Prior Art

A web site may be developed to include images for display thereon that are compiled from a library of images within a specific color theme. This facilitates the development process and enables selection of images within a defined category and defined color theme subsequent to the development process. In addition, the library of images within the color theme may be employed to dynamically change the images of the web site based upon a user color preference. This enables the presentation of the web site to be customized for each user based upon their color preference. The process of dynamically customizing the web site presentation includes selecting new images to replace the original images. In one embodiment, the new images may be the same image with a different color enhancement. Similarly, in one embodiment the replacement images may be different images with a similar topic and a matching color. There are different combinations and permutations for selecting images from the library to match the color preference of the user with the objective being to customize the web site for the user as an attempt to keep the user at the subject web site or to encourage the user to return to the subject web site at a later time.

### Alternative Embodiments

It will be appreciated that, although specific embodiments of the invention have been described herein for purposes of illustration, various modifications may be made without departing from the spirit and scope of the invention. In particular, in one embodiment a web site may employ a tool to determine a color preference for a visitor. The tool may discern this information from a history of sites visited by the user. Similarly, the tool may enable the user to directly input the user color preference for display. For example, if the user is color blind or otherwise has a select range of colors that they can see and appreciate, then they may directly communicate their color preferences to the development manager. In one embodiment, the color preferences may be set in the browser program of the computer system. Furthermore, the library of images may include for each image a series of color palettes. This enables the same themed image to be selected with a color that is appropriate for the site and/or user. The development manager may customize a web site to be visited based upon the color preference of the user together with the appropriate image from the color palette in the library.

Furthermore, in one embodiment, the color spectrum for an image may be specified in the file name or by a hexadecimal value. Similarly, in one embodiment, the color of one image can be modified to create multiple images, with each image having a different color assignment that matches a category of colors in the library. Accordingly, the scope of protection of this invention is limited only by the following claims and their equivalents.

I claim:

1. A method for developing a web site comprising:
classifying each image in a collection of images for display with at least one color attribute, wherein said color attribute classification reflecting a color in said image;
obtaining a color preference for said web page; and
displaying at least one of said images from said collection on said web page wherein said displayed image has a color associated with said color preference of said web page.

2. The method of claim 1, wherein the color associated with said color preference of said web page includes an image with a color matching said web page color preference.

3. The method of claim 1, wherein the color associated with said color preference of said web page includes an image selected from a color spectrum closest to said color preference.

4. The method of claim 1, further comprising storing said color of said image in a hexadecimal value in a filename of said image.

5. The method of claim 1, further comprising organizing said collection of images in a directory structure and determining a color attribute of each image in said collection according to its placement in said directory structure.

6. The method of claim 1, further comprising organizing said image collection into a data structure having at least one color identifier and a list of images from said collection that are associated with said color identifier.

7. The method of claim 1, further comprising selecting a default image to be displayed on said web page in response to none of said images in said collection of images having a color matching said web page color preference.

8. A computer system comprising:
a processor in communication with a storage media and a visual display;
a collection of images for display on a web page stored on said storage media;
an image manager in communication with said processor and said collection of images to classify each of said images in said collection with at least one color attribute;
a development manager in communication with said image manager, and said development manager to obtain a color preference for said web page; and
said visual display in communication with said development manager to display at least one of said images from said collection on said web page on said visual display, wherein said displayed image has a color associated with said color preference of said web page.

9. The system of claim 8, wherein the color associated with the color preference of said web page includes an image with a color matching said web page color preference and an image selected from a color spectrum closest to said color preference.

10. The system of claim 8, wherein the color associated with the color preference of said web page includes an image selected from a color spectrum closest to said color preference.

11. The system of claim 8, further comprising said image manager to store said color of said image in a hexadecimal value in a filename of said image.

12. The system of claim 8, further comprising said image manager to organize said collection of images in a directory structure and to determine a color attribute of each image in said collection according to its placement in said directory structure.

13. The system of claim 8, further comprising said image manager to organize said image collection into a data structure having at least one color identifier and a list of images from said collection that are associated with said color identifier.

14. An article comprising:
a computer readable carrier including computer program instructions configured to select one or more images to be displayed on a web page, said instructions comprising:
instructions to classify each of image in a collection of images for display on a web page with at least one color attribute, wherein said color attribute classification reflecting a color in said image;
instructions to obtain a color preference for said web page; and
instructions to display at least one of said images from said collection on said web page wherein said displayed image has a color associated with said color preference of said web page.

15. The article of claim 14, wherein the color associated with said color preference of said web page includes an image with a color matching said web page color preference.

16. The article of claim 14, wherein the color associated with said color preference of said web page includes an image selected from a color spectrum closest to said color preference.

17. The article of claim 14, further comprising instructions to store said color of said image in a hexadecimal value in a filename of said image.

18. The article of claim 14, further comprising instructions to organize said collection of images in a directory structure and determining a color attribute of each image in said collection according to its placement in said directory structure.

19. The article of claim 14, further comprising instructions to organize said image collection into a data structure having at least one color identifier and a list of images from said collection that are associated with said color identifier.

20. An article comprising:
a tangible computer readable carrier including computer program instructions configured to select one or more images to be displayed on a web page, said instruction comprising:
instructions to create a collection of images for display on a web page;
instructions to classify each of said images in said collection with at least one color attribute, wherein said color attribute classification reflecting a color in said image;
instructions to obtain a color preference for said web page; and
instructions to display at least one of said images from said collection on said web page wherein said displayed image has a color associated with said color preference of said web page.
